(19) United States
(12) Patent Application Publication
(10) Pub. No.: US 2005/0083673 A1
(43) Pub. Date: Apr. 21, 2005

(54) Optical glare limiter

(76) Inventor: Uwe Peter Braun, Lenzen (DE)

Correspondence Address: WILLIAM COLLARD;COLLARD & ROE, P.C., 1077 NORTHERN BOULEVARD, ROSLYN, NY, 11576, US

(21) Appl. No.: 10/495,608

(22) PCT Filed: Nov. 19, 2001
(86) PCT No.: PCT/EP01/13345

(51) Int. Cl. F21W 11/02

(52) U.S. Cl. 362/31

(57) ABSTRACT

The invention relates to an optical anti-dazzle device, more particularly for motor vehicles, with a light receiving component (2) and a light source (3), the light emission of which can be controlled in dependence on the light emission of a source of dazzle. In order to achieve such a relatively large, mainly homogeneously shining surface in such a anti-dazzle device in spite of its compact, flat dimensions, according to the invention the light source (3) is assigned a flat light guide (5) with at least one narrow edge surface (6) and at least one flat light emission surface (10), wherein the light from the light source (3) can be launched via the narrow edge surface (6), and the area of the light emission surface (10) is a multiple of the area of the narrow edge surface used for launching light. Another form of embodiment of the anti-dazzle device according to the invention consists in the light source being formed by a luminous film, which can be activated by an electronic device in such a way that the luminous film forms an essentially homogeneously shining surface. A further embodiment of the anti-dazzle device according to the invention consists in the light source comprising organic light-emitting diodes which are arranged on at least one glass carrier or at least one flexible, transparent carrier made of plastic.

The invention relates to an optical anti-dazzle device, particularly for motor vehicles, with at least one light receiving component and at least one light source, the light emission of which can be regulated in dependence on the light emission from an external source of dazzle.

It is known that the ability of the human eye to register and perceive ambient brightness, colour and shape structures more or less quickly, as well as its adaptability, are essentially dependent on the luminous intensity of the light emission reaching the eye and the differences in light intensity in the field of vision. With too high luminous intensities in the field of vision, the ability of the eye to perceive and therefore to see can be considerably impaired. This type of effect, which seriously impairs the primary function of the eye, is called dazzlement.

It is also known that in road traffic at night many accidents are due to the absence of or wrong reaction by the driver as a result of the eyes being dazzled. During night-time driving the ciliary muscles of the eyes are tensed to a greater or lesser degree depending on the visual focus point. The pupil is relatively dilated and the eye is adapted to the mean luminous intensity prevailing in the field of vision. If, for example, the mean luminous intensity changes due to the light from an on-coming vehicle, the process of adaption from one state of adaptation to another requires a certain amount of time, which is dependent on the prior illumination of the eye, the direction of adaptation and the difference in luminous intensity before and after the adaptation. The greater the difference from the luminous intensity prevailing before adaptation brought about by the light from on-coming vehicles, the more the retina is irritated, the requirements relating to the rate of brightness and darkness adaptation are increased, and the scattered light generated within the eye causes a veil on the retina and finally an impaired visual ability. The consequences are, among others, that on-coming vehicles are often only recognised unclearly or too late, and distances are judged incorrectly as a result of which the driver may react inappropriately.

The increasing number of xenon-based vehicle headlights is increasing further the dangers arising from the harmful effects of the greater luminous intensity of this type of lamp compared with conventional halogen headlights. Studies have shown that test subjects in all age groups feel annoyed by xenon light, irrespective of the measurable impairment of vision. Older people in particular could no longer perceive certain contrasts in the case of on-coming xenon light (Der Spiegel, 7/1998, pages 168 ff).

From DE 199 41 125 A1, submitted by the applicant, an optical anti-dazzle device of the aforementioned type is known. The anti-dazzle device comprises a light-receiving component and a light source, whereby the light emission from the light source can be regulated depending on the intensity of the light reaching the light-receiving component from an external source of dazzle in such a way that the light emission in the field of vision causes a reduced dazzling effect. The light source is provided with a reflector and a prism and, together with the light-receiving component, is arranged in a casing, preferably located on or in the sun-visor of the vehicle in a pivoting or folding manner. The prism is, for example, a longitudinal prism with saw-tooth-like prisms arranged in opposite directions, whereby the prisms deflect the light emission from the light source in two light beams. The prism can also be provided with a diffuser in the form of an opal disk. A commercially available glass pedestal lamp is used as the light source. However, light-emitting diodes can also be used as the light source.

The principle of this known optical anti-dazzle device is essentially advantageous. However, it has been shown that this anti-dazzle device is of relatively large structural volume if it is to have a relatively large diffuse luminous surface for reducing the dazzle effect.

The aim of the present invention is therefore to bring about an improved anti-dazzle device which can be designed to be relatively flat, but still have a relatively large, mainly homogeneous luminous surface.

According to the invention this object is achieved by means of an anti-dazzle device of the type in question in that a flat light guide is assigned to the light source, which has a relatively narrow edge surface and a flat light emission surface, wherein the light from the light source can be launched via the small edge surface in the light guide, and wherein the area of the light emission surface is a multiple of the narrow edge area used for launching light.

An optical anti-dazzle device in accordance with the invention can be produced in a very flat shape, whereby despite its relatively small size it has a relatively large, mainly homogenous diffusely luminous surface.

A preferred embodiment of the anti-dazzle device according to the invention is characterised in that the light source consists of light-emitting diodes arranged in a row. This achieves relatively even light launching into the flat light guide, and thereby largely homogeneous light emission from the anti-dazzle device.

Another preferred embodiment of the anti-dazzle device according to the invention is characterised in that the light source has additional light-emitting diodes, which emit light in the UV-A spectrum. Tests have shown that radiation in the UV-A spectrum counteracts tiring of the test subjects. Through the use of UV-A light-emitting diodes in addition to conventional light-emitting diodes the period for which a vehicle driver can drive without becoming tired is prolonged.

In a further advantageous embodiment the anti-dazzle device can have several light sources and several light-receiving components at a distance from each other, whereby the light-receiving components are connected to a control device by means of which the light emission of the relevant light source can be controlled in such a way in dependence on the light emission of at least one dazzle source and at least one other light source that at its light emitting surface the anti-dazzle device shines with different brightnesses so that an area which is close to the other light source shines less brightly than an area which is further away from the other light source. This design allows the setting of areas of different light emission and/or brightness on the light emitting surface of the anti-dazzle device compared with other light sources, e.g. car interior lighting, so that in the driver's field of vision overall balanced lighting is always guaranteed. The intensities of the light emission from another dazzle source and a light source located inside the vehicle, e.g. a reading lamp, are registered by way of the at least two light-receiving components and the output signals of the light-receiving component are evaluated by the control device.

The light source and the narrow edge surface used for light launching are preferably arranged with regard to a person to be protected against dazzling in such a way that the emission direction of the light launched in the light guide is turned away from the field of vision. This rules out dazzling of the person by the light source of the anti-dazzle device itself.

The flat light guide consists of a massive body or alternatively has a light-guiding hollow space which is bounded by a light-permeable plate and a light-impermeable plate.

In order to achieve a large relatively homogeneous luminous surface it is beneficial when using a flat light guide if this has a reflecting coating and/or printing on its side opposite the light emission surface. The reflecting printing and/or coating preferably has a varying layer thickness, so that the layer thickness increases with increasing distance from the light source.

The object of the invention can also be achieved in that the light source is formed of a luminous film which can be stimulated electronically in such a way that the light film essentially represents a homogeneous luminous surface.

A further solution of the object of the invention consists in the light sources being formed of organic light-emitting diodes (so-called OLEDs), which are arranged on at least one glass carrier or at least one flexible transparent carrier made of plastic.

Other preferred and advantageous embodiments of the anti-dazzle device in accordance with the invention are set out in the sub-claims.

The invention will be described in more detail below with reference to drawings showing several examples of embodiment. Schematically

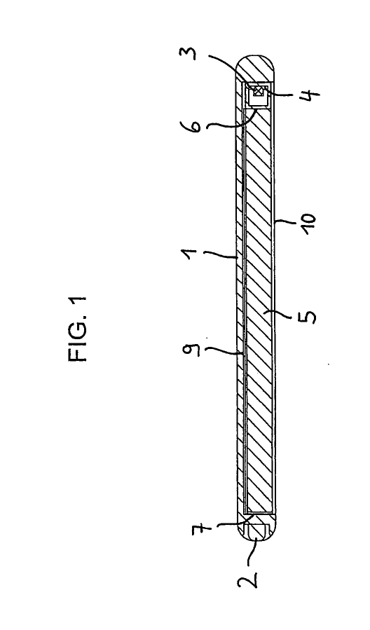

FIG. 1 shows a cross-section of an optical anti-dazzle device with a flat light guide in accordance with a first embodiment,

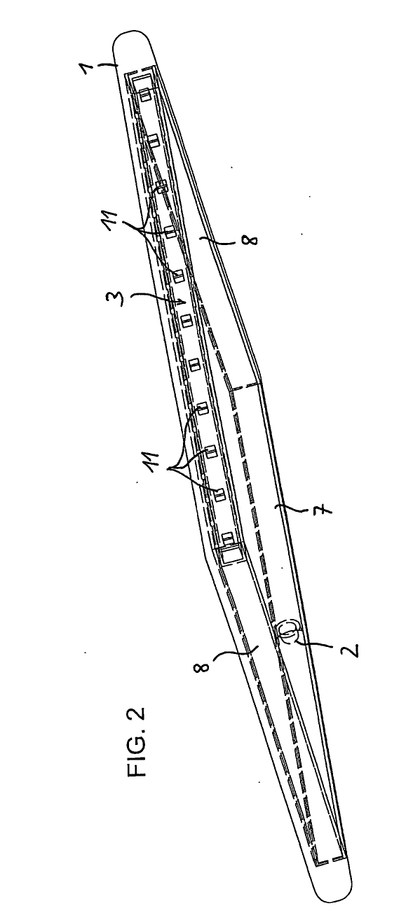

FIG. 2 shows a perspective view of the anti-dazzle device according to FIG. 1,

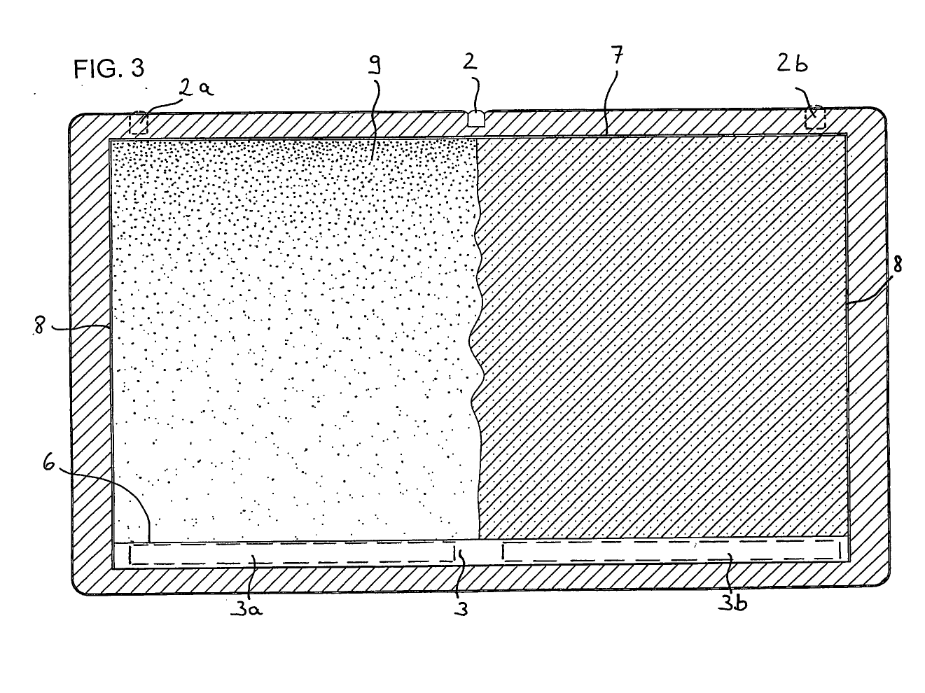

FIG. 3 shows a plan view of a longitudinal section through the anti-dazzle device according to FIG. 1 in the area of the interior of the flat light guide,

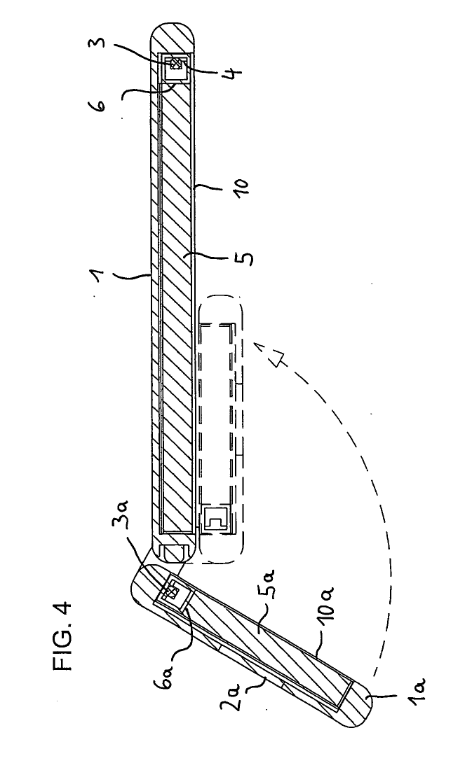

FIG. 4 shows a cross-section of a two-part optical anti-dazzle device with two flat light guides in accordance with a second form of embodiment,

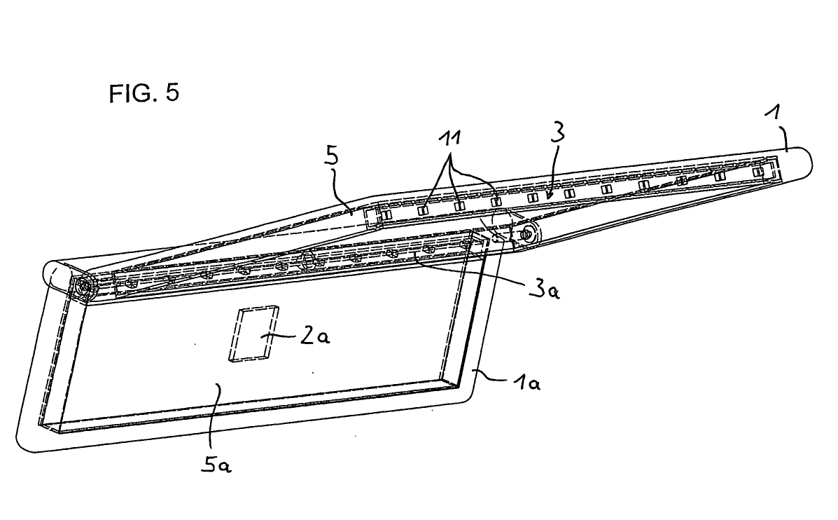

FIG. 5 shows a perspective view of the anti-dazzle device in accordance with FIG. 4,

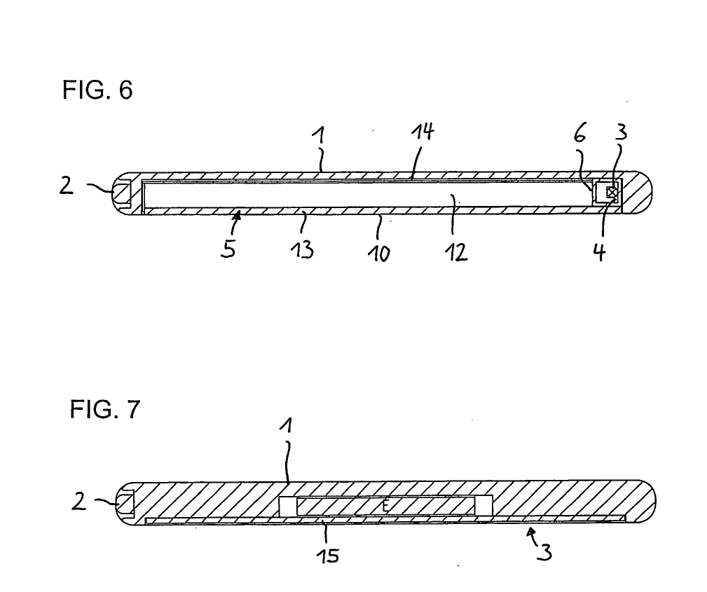

FIG. 6 shows a cross-section of an optical anti-dazzle device with a flat light guide according to a third form of embodiment

FIG. 7 shows a cross-section of an optical anti-dazzle device with a luminous film as the light source according to a fourth form of embodiment,

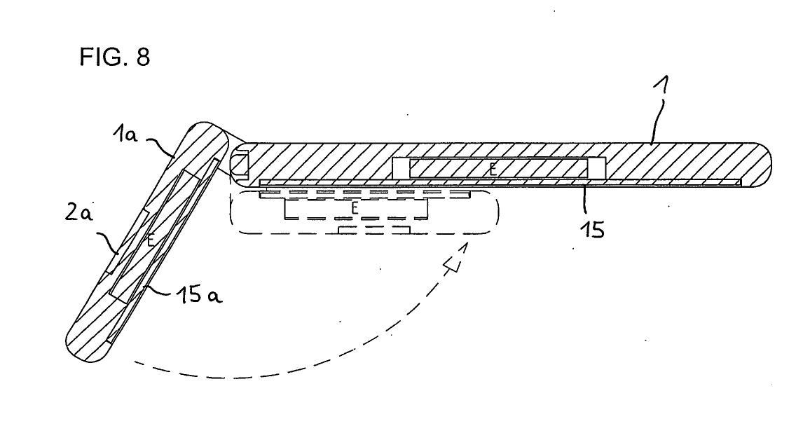

FIG. 8 shows a cross-section of a two-part optical anti-dazzle device with two luminous films in accordance with a fifth embodiment of the invention, and

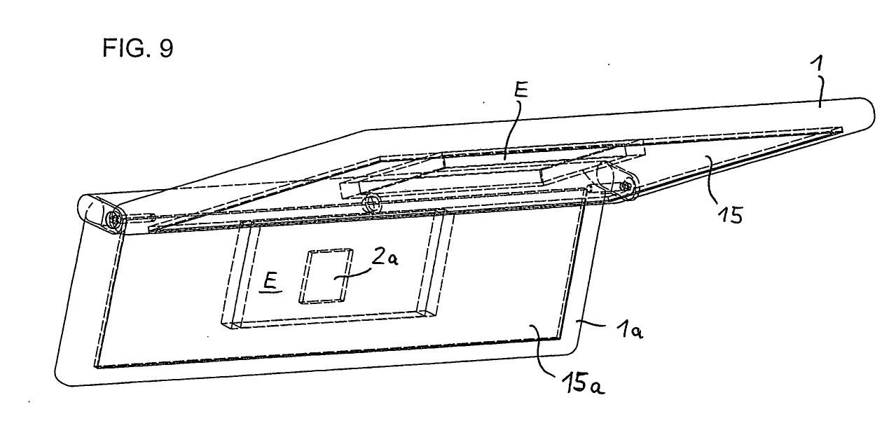

FIG. 9 shows a perspective view of the anti-dazzle device according to FIG. 8.

The optical anti-dazzle device shown in FIGS. 1 to 3 comprises a casing 1, which is preferably designed as a sun-visor for assembly in a motor vehicle. On its front longitudinal side the casing or sun-visor 1 has a light receiving component 2 which when the anti-dazzle device is in operation faces the windscreen of the motor vehicle. A photo diode is used as the light receiving component. Alternatively, however, photo-transistors, photo-resistors, light/frequency converters, light/voltage converters, fluorescence collectors or solar cell bars can be used.

Also arranged in the casing 1 is a light source 3 which is provided with a reflector 4. Assigned to the light source 3 is a flat plate-shaped light guide 5 in which the light from the light source 3 is launched via a narrow edge surface or cut edge 6. The reflector 4 directs the light emitted from the light source 3 onto the edge surface 6. The light source 3 and the edge surface 6 of the light guide 5 are arranged in relation to a person to be protected against dazzling in such a way that the emission direction of the light launched in the light guide 5 is facing away from the visual field of the person to be protected against the effects of dazzle.

The edge surface 7 opposite the light source 3 is provided with a reflecting layer, for example a mirror surface. Preferably the edge surfaces, marked 8, of the flat light guide 5 are also provided with a reflecting layer. The interior 9 of the light guide 5 is shown in FIG. 3. It also has a mirror surface or another type of reflecting surface as shown by the hatching on the right-hand side of FIG. 3. Alternatively the interior 9 of the light guide 5 can also be provided with reflecting printing, as shown schematically on the left-hand side of FIG. 3. The reflecting printing, which consists, for example, of fluorescent colour material, has a varying layer thickness with the layer thickness increasing with increasing distance from the light source 3. Alternatively the printing can consist of colour elements, e.g. dots, stripes or other small elements with regular and/or irregular contours, whereby the colour elements are arranged in different densities, namely in such a way that the density gradually increases with increasing distance from the light source 3. This is shown schematically by way of the increasing dot density in the direction of the light receiving component 2.

The exterior of the light guide 5 forms the light emission surface 10 from which the light launched in the light guide is emitted in the direction of the field of vision of a person to be protected against the effect of dazzle. The area of the light emission surface 10 is a multiple of the area of the edge surface 6.

The plate-shaped light guide 5 is formed as solid body in the shown example of embodiment and consists of glass or a glass-like plastic, for example acrylic glass.

In the example of embodiment shown in FIG. 1 to 3 the light source 3 comprises several light-emitting diodes 11 arranged in series. The light-emitting diodes 11 thus form a light-emitting diode bar. The number of light-emitting diodes 11 and the distance between them is not restricted to the shown example of embodiment. Rather, the number of light-emitting diodes used can be greater and the distance between them smaller. Besides conventional light-emitting diodes the anti-dazzle device can also contain light-emitting diodes which emit rays in the UV-A spectrum. It is also possible to allocate two light-emitting diode bars to the plate-shaped light guide 5 by using the opposite lateral edge surfaces or cross-section edges 8 of the light guide 5 as light coupling points.

The anti-dazzle device also includes electronic controls (not shown) used for regulating the light emission of the light source in dependence on the light emission of an external dazzle source registered by the light receiving component 2. As soon as the dazzling light of an on-coming vehicle reaches the light receiving component 2, depending on its luminous intensity the light source 3 of the anti-dazzle device becomes brighter or darker so that the difference in light intensity between the light from the on-coming vehicle and that of the hitherto mean luminous intensity in the field of vision of the vehicle driver is reduced.

The anti-dazzle device or its electronic control device are equipped with a light sensor (not shown) which registers the brightness of the ambient light. The output signal of this light sensor is evaluated in the electronic control device. If a predeterminable brightness value is not attained, such as in the case of twilight, the light source of the anti-dazzle device is automatically switched on at a predeterminable basic brightness by the electronic control device. By way of a switch (which is not shown) the basic brightness of the light source 3 can be varied, independently of a stand-by setting, by selecting a different control setting. In this way it is possible to manually adjust the basic brightness of the light source 3 and thereby the basic brightness of the light emission surface 10 in the field of vision of the driver in accordance with individual perception ability. The power supply for the anti-dazzle device comes from the electrical system of the motor vehicle.

In FIGS. 4 and 5 a second form of embodiment of the optical anti-dazzle device in accordance with the invention is shown. This form of embodiment differs from the form of embodiment in FIGS. 1 to 3 in that two light sources or light-emitting diode bars 3, 3a are now present, to each of which a flat light guide 5, 5a is assigned in which the light of the associated light source 3, 3a can be launched via a narrow edge surface 6, 6a and which has a flat light emission surface 10, 10a, the area of which is a multiple of the narrow edge surface 6, 6a which is used for launching light. Together with their associated light sources 3, 3a, the two flat light guides 5, 5a are each attached to a carrier or casing 1, 1a. The two casings 1, 1a are connected to each other in a pivoting manner on their longitudinal sides. Thus. the anti-dazzle device in accordance with FIG. 4 has a larger overall light emission surface than the anti-dazzle device according to FIG. 1. In this form of embodiment a light receiving component 2a is arranged in a recess on the rear and/or lower side of the pivoting casing 1a of anti-dazzle device. The pivoting section 1a of the anti-dazzle device is smaller than the fixed part 1. The pivoting part 1a can be pivoted to underneath the larger fixed section 1 as indicated by the broken line in FIG. 4. In the fully pivoted in position the light emission surfaces 10, 10a closely adjoin each other.

A further example of embodiment of the anti-dazzle device according to the invention is shown in FIG. 6. This form of embodiment differs from the forms of embodiment shown in FIGS. 1 to 3 in that the flat light guide is not designed as a massive body, but has a light-guiding hollow space 12 which is bounded by a light-permeable plate 13 and a light-impermeable plate 14. The two plates 13, 14 which are essentially arranged in parallel to each other can each consist of light-permeable plastic with plate 14, arranged on the inner side of the anti-dazzle device, being provided with a reflecting coating and/or printing.

The form of embodiment shown in FIG. 7 differs from the forms of embodiment shown in FIGS. 1 to 6 in that the light source is formed by a luminous film 15 which can be activated by an electronic device E of a control device in such a way that the luminous film 15 represents an essentially homogeneous luminous area. The luminous film 15 essentially extends over the entire underside of the casing 1 of the anti-dazzle device. The luminous film 15 can be electronically activated and produces a homogeneous intensity over its entire area. The luminous film 15 is operated by the electronic device in the control device using an alternating voltage with a frequency of 1 KHz. The electronic device E incorporates a transformer which acts as a series-connected device. The anti-dazzle devices shown in FIGS. 6 and 7 can, like the anti-dazzle device in accordance with FIG. 4, be designed in two parts in order to achieve a larger light emission surface. This is shown as an example in FIGS. 8 and 9 with reference to the form of embodiment in accordance with FIG. 7. It can be seen that two luminous films 15, 15a are present, which are each attached to a carrier or casing 1, 1a, and that both casings 1, 1a are in turn connected to each other in a pivoting manner.

The invention is not restricted to the forms of embodiment described above. Rather, several variants are conceivable which even if designed in a fundamentally different way still make use of the inventive idea expressed in the claims. For example, it is possible for the light source 3 of the anti-dazzle device to consist of organic light-emitting diodes, which are arranged on at least one carrier made of glass or a flexible, transparent carrier made of plastic.

The anti-dazzle device according to the invention can also comprise several independently controllable light sources 3 and several light receiving components 2, arranged at a distance from each other, whereby the light receiving components 2 are connected to a control device by means of which the light emission from the relevant light source 3 can be controlled in dependence on the light emission from at least one source of dazzle and at least one other light source (e.g. a reading light in the interior of the vehicle) in such a way that the anti-dazzle device at its light emission surface 10 shines with areas of different brightness in such a way that an area lying close to the other light source shines less brightly than an area lying further away from the other light source. In this way balanced illumination of the field of vision of a person to be protected from dazzle can be achieved so that both eyes of the person to be protected see light emission with almost identical luminous density. In FIG. 3 the use of several, independently controllable light sources 3a, 3b as well as several light receiving components 2a, 2b arranged at a distance from each other are shown by broken lines.

1-16. (canceled)

17. Optical anti-dazzle device, particularly for motor vehicles, with at least one light receiving component (2) and at least one light source (3), the light emission of which can be controlled in dependence on the light emission of a source of dazzle,
wherein, assigned to the light source (3) is a flat light guide (5) which has at least one narrow edge surface (6) and a flat light emission surface (10), wherein the light from the light source (3) can be launched via the narrow edge surface (6) in the light guide, and the area of the light emission surface (10) is a multiple of the narrow edge surface (6) used for launching light, and wherein the light guide (5) has on its side opposite the light emission surface (10) a reflecting coating and/or printing which is of varying layer thickness so that the layer thickness increases with increasing distance from the light source (3) or which is formed of a number of individual colour and/or picture elements which are of varying densities in such a way that the density creases with increasing distance from the light source (3).

18. Optical anti-dazzle device according to claim 17, wherein the light guide (5) has a reflecting edge surface (7) which lies opposite the narrow edge surface (6) used for launching light.

19. Optical anti-dazzle device according to claim 17, wherein, with the exception of the narrow edge surface (6) used for launching light, all the narrow edge surfaces (7, 8) of the light guide (5) have a reflecting coating.

20. Optical anti-dazzle device according to claim 17, wherein the light source (3) is provided with a reflector (4) which deflects the light emitted from the light source (3) to the narrow edge surface (6), used for launching light, of the light guide (5).

21. Optical anti-dazzle device according to claim 17, wherein the light source (3) comprises light-emitting diodes (11) arranged in series.

22. Optical anti-dazzle device according to claim 17, wherein the light source has light-emitting diodes which emit UV-A rays.

23. Optical anti-dazzle device according to claim 17, wherein the light source (3) and narrow edge surface (6), used for launching light, of the light guide (5) are arranged with regard to the person to be protected from the effect of dazzle in such a way that the direction of emission of the light launched in the light guide (5) is away from the field of vision of the person to be protected against the effect of dazzle.

24. Optical anti-dazzle device according to claim 17, wherein the light guide (5) is formed of a massive light-guiding body.

25. Optical anti-dazzle device according to claim 17, wherein the light guide (5) has a light-guiding hollow space (12) which is bounded by a light-permeable place (13) and a light-impermeable plate (14).

26. Optical anti-dazzle device, particularly for motor vehicles, with at least one light receiving component (2) and at least one light source (3), the light emission of which can be controlled in dependence on the light emission of source of dazzle,
wherein the light source comprises a luminous film (15), which can be activated by an electronic device (E) in such a way that the luminous film (15) forms an essentially homogeneously illuminated surface.

27. Optical anti-dazzle device, particularly for motor vehicle, with at least one light receiving component (2) and at least one light source, the light emission of which can be controlled in dependence on the light emission of a source of dazzle, wherein, the light source is formed of organic, light-emitting diodes, which are arranged on at least one glass carrier or on at least one flexible, transparent carrier made of plastic.

28. Optical anti-dazzle device according to claim 17, wherein the anti-dazzle device is divided into at least two casings (1, 1a), which each have a light source and a light emission surface and are connected to each other in a pivoting manner.

29. Optical anti-dazzle device according to claim 17, wherein several light sources (3a, 3b) and several light receiving components (2a, 2b), which are at a distance from each other, are present, whereby the light receiving components are connected to a control device by means of which the light emission from the relevant light source (3a, 3b) can be controlled in dependence on the light emission of at least one source of dazzle and at least one other light source in such a way that at its light emission surface (10) the antidazzle device shines with areas of differing brightness in such a way that an area lying close to the other light source shines less brightly than an area lying further away from the other light source.
